(19) United States
(12) Patent Application Publication
(10) Pub. No.: US 2011/0141404 A1
(43) Pub. Date: Jun. 16, 2011

(54) OUTDOOR LARGE AREA DISPLAY DEVICE AND MANUFACTURING METHOD OF THE SAME

(76) Inventors: Sejune Kim, Paju-si (KR); Woonam Jeong, Paju-si (KR)

(21) Appl. No.: 12/774,418

(22) Filed: May 5, 2010

(30) Foreign Application Priority Data
Dec. 14, 2009 (KR) 10-2009-0124038

(51) Int. Cl. G02F 1/1347; H01J 9/24; H01J 1/62

(52) U.S. Cl. 349/74; 445/24; 313/503

(57) ABSTRACT

The present disclosure relates to an outdoor large area flat panel display device and a manufacturing method of the same. The present disclosure suggests an outdoor large area flat panel display device comprising: a reinforced base substrate; an anti-reflection film disposed on the outer surface of the base substrate; black matrixes dividing the inner surface of the base substrate into 4 sections; an index matching oil disposed on the inner surface of the base substrate; and a first, a second, a third and a fourth flat panel modules tiled on the base substrate bordering the black matrixes. The present disclosure suggests a large area flat panel display device having strength enough to endure from external impacts and optical properties as the large display panel is made in one piece of panel.

This application claims the benefit of Korea Patent Application No. 10-2009-0124038 filed on Dec. 14, 2009, which is incorporated herein by reference for all purposes as if fully set forth herein.

### BACKGROUND

1. Field of the Invention

The present disclosure relates to an outdoor large area flat panel display device and a manufacturing method of the same. Specifically, the present disclosure relates to the large area flat panel display device for presenting public information at outdoor and the method for manufacturing the same.

2. Discussion of the Related Art

Nowadays, in the display device market, for replacking cathode ray tube (or “CRT”) having heavy and large volume, various flat panels have been developed. For these flat panel display device, there are liquid crystal display (or “LCD”) device, field emission display (or “FED”), plasma display panel (or “PDP”), organic light emitting device (or “OLED”), etc.

The active matrix liquid crystal display device (or, “AMLCD”) shows moving pictures or video data using a thin film transistor (or, “TFT”) as the switching element. Compared with the cathode ray tube (hereinafter “CRT”) display device, the LCD device has a small and thin size and is light weight. Therefore, it is rapidly being applied to portable communication & information devices, official automation appliances, computer monitors, as well as TV monitors by replacing the CRT.

FIG. 1 is a perspective view illustrating a simple structure of the AMLCD. The AMLCD comprise a TFT substrate 10 having TFTs arrayed in matrix type, a color filter substrate 30 on which color filters of red, green or blue color are arrayed in matrix type. At the inside surfaces of the TFT substrate 10 and the color filter substrate 30, alignment layers 11 and 31 are deposited, respectively. The TFT substrate 10 and the color filter substrate are joined each other with facing each other. A liquid crystal layer 20 is inserted between the TFT substrate 10 and the color filter substrate 30.

FIG. 2 is a diagram illustrating the structure of an organic light emitting diode included in the organic light emitting diode (or, “OLED”). The OLED emits light by forming an exiton when the hole generated at the anode electrode and the electron generated at the cathode electrode are jointed at the emission layer after they are passing through the hole injection layer and the electron injection layer, respectively. The organic light emiting diode display device having OLED as shown in FIG. 2 represents the video data by electrically controlling the amount of the light generated at the emission layer (or “EML”). The organic light emitting diode comprises a cathode electrode and an anode electrode face each other with the organic electroluminescent layer therebetween. The electroluminescent layer comprises the hole injection layer (or “HIL”), the hole transport layer (or “HTL”), the emission layer (or “EML”), the electron transport layer (or “ETL”) and the electron injection layer (or “EIL”).

An organic light emitting diode display device (or, “OLEDD”) is generally classified in two kinds; the one is the passive matrix type organic light emitting diode display device (or “PMOLED”), and the other is the active matrix type organic emitting diode display device (or “AMOLED”). The AMOLED represents the video data by controlling the electric currents flowing in the OLED using TFTs.

These flat panels are used as the display devices for monitors, television sets and various portable digital devices. Most of them are used in indoor conditions. Even thought they are used outdoors, they may be exposed under the sunlight for just a short time period. Public information display devices, however, should have a large display area for viewing at long distances, and better endurance to sunlight and external influences. Therefore, it is hard to develop LCDs or OLEDDs for outdoor public information display devices because they are weak against the external influences and are hard to make in a large area over 100 inch panel.

### BRIEF SUMMARY

An outdoor large area flat panel display device comprises: a reinforced base substrate; an anti-reflection film disposed on the outer surface of the base substrate; black matrixes dividing the inner surface of the base substrate into 4 sections; an index matching oil disposed on the inner surface of the base substrate; and a first, a second, a third and a fourth flat panel modules tiled on the base substrate bordering the black matrixes.

Additionally, the present disclosure is directed to a manufacturing method of an outdoor large area display device comprising: preparing a reinforced base substrate; disposing an anti-reflection film on the outer surface of the base substrate; forming black matrixes dividing the inner surface of the base substrate into 4 sections; disposing an index matching oil on the inner surface of the base substrate over the black matixes; tiling a first flat panel module at a first section of the base substrate; tiling a second flat panel module at a second section of the base substrate; tiling a third flat panel module at a third section of the base substrate; tiling a fourth flat panel module at a fourth section of the base substrate; and hardening the index matching oil.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating a simple structure of the active matrix liquid crystal display device.

FIG. 2 FIG. 2 is a diagram illustrating the structure of an organic light emitting diode included in the organic light emitting diode.

FIG. 3 is a perspective view illustrating one module of liquid crystal display panel according to the present disclosure.

FIGS. 4A to 4F perspective views illustrating a method for manufacturing an outdoor large area display device by tiling 4 LCD modules showing in FIG. 3 according to the present disclosure.

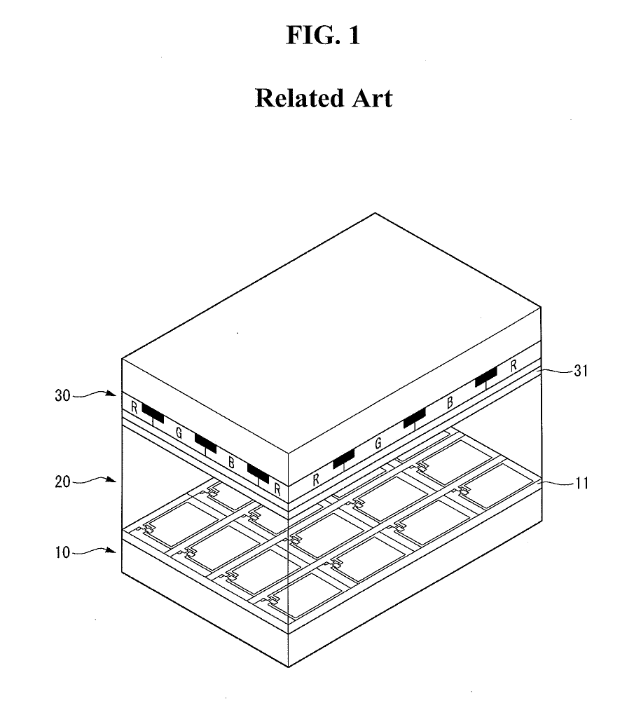

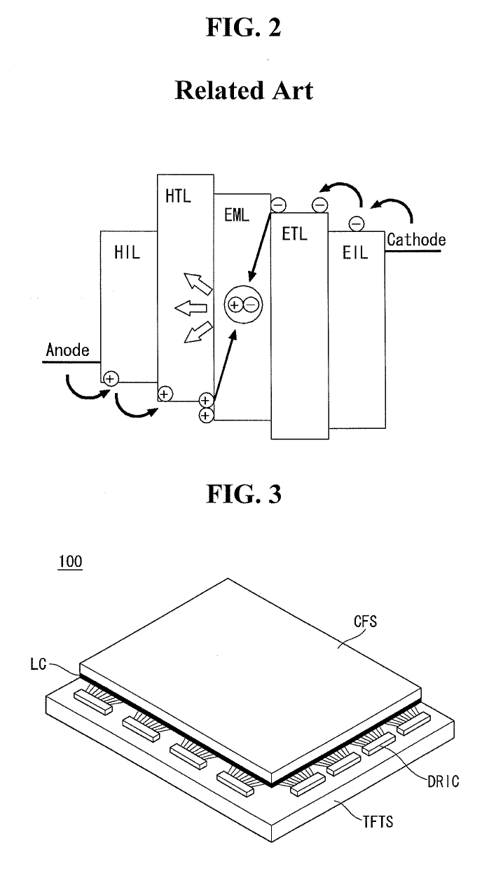

### DETAILED DESCRIPTION OF THE DRAWINGS AND THE PRESENTLY PREFERRED EMBODIMENTS

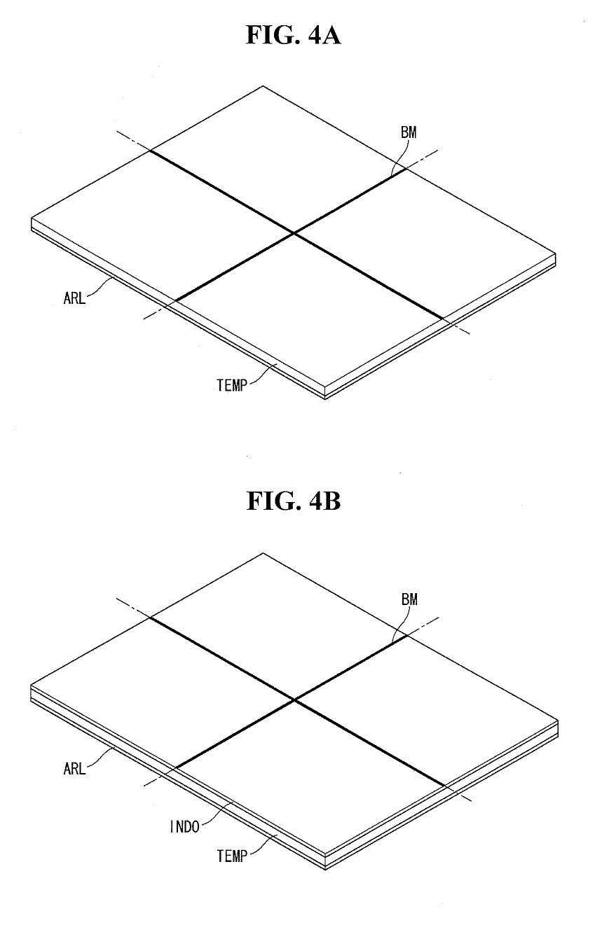

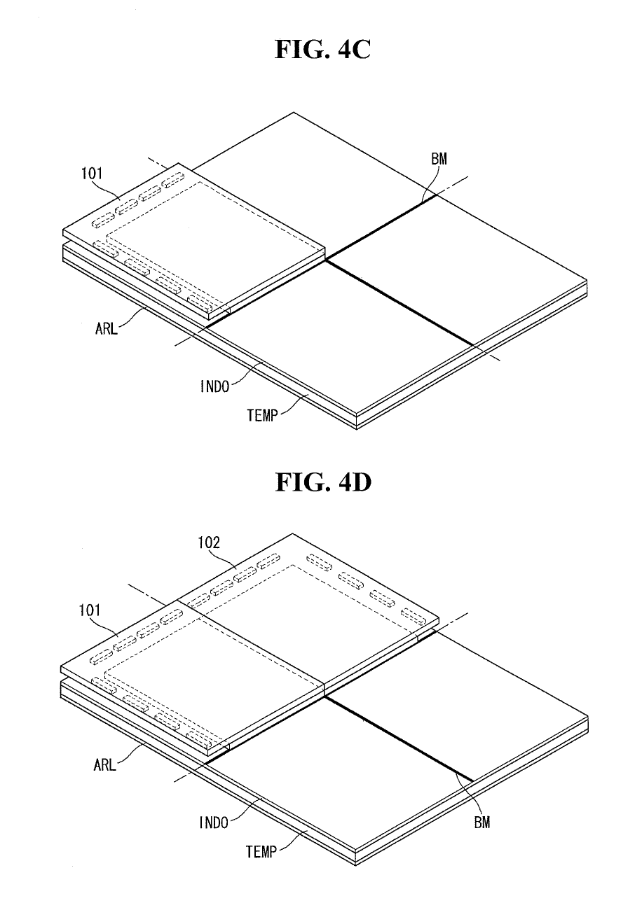

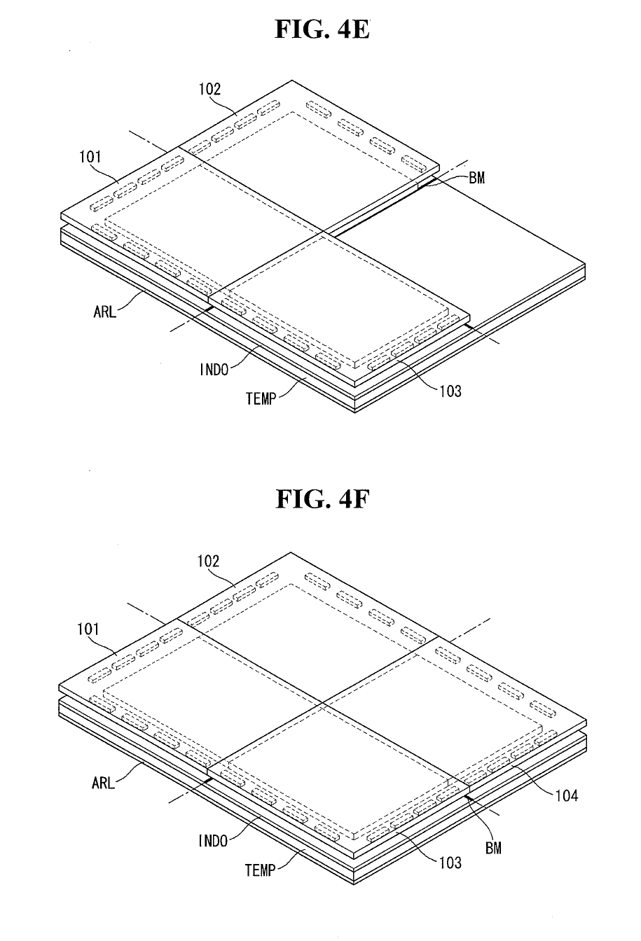

Referring to attached FIGS. 3 to 4F, an outdoor large area display device and a method for manufacturing the same according to the preferred embodiment of the present disclosure will be explained in detail. Advantages and features of the present invention and a method of achieving the advantages and the features will be apparent by referring to embodiments described below in detail in connection with the accompanying drawings. Like reference numerals designate like elements throughout the detailed description. FIG. 3 is a perspective view illustrating one module of liquid crystal display panel according to the present disclosure. FIGS. 4A to 4F perspective views illustrating a method for manufacturing an outdoor large area display device by tiling 4 LCD modules showing in FIG. 3 according to the present disclosure.

Referring to FIG. 3, a modue of the liquid crystal display panel has rectangular shaped panel including a color filter substrate CFS and a TFT substrate TFTS, which join each other with a liquid crystal layer LC therebetween. The TFT substrate TFTS has a larger area than the color filter substrate CFS. Specifically, two neighboring sides of the TFT substrate TFTS are aligned with two neighboring sides of the color filter substrate CFS. Therefore, the other two neighboring sides of the TFT substrate TFTS are oversized. At these areas, which are oversize relative to the color filter substrate CFS, the driver ICs DRIC for driving the module of the LCD are installed.

According to currently used technologies, the maximum size of the flat display panel, for example the liquid crystal display panel with whole one glass is not over 60 inches in diagonal length. Most LCD panels manufactured in mass production, the diagonal length is about 40 to 52 inches. If the target diagonal size of the LCD panel is 5 inches longer, the manufacturing conditions will be totally different. Therefore, it is desirable to develop technologies for manufacturing a larger LCD panel than 80 inches diagonal length. Consequently, the present disclosure suggests the method for manufacturing a large area flat panel display device by tiling 4 flat display panel modules which can be manufactured by a mass production technology. Specifically, the present disclosure suggests a large area display panel used for presenting public information outdoors, and the method for manufacturing the same.

Hereinafter, referring to FIGS. 4A to 4F, the method is explained for manufacturing an outdoor large area LCD by tiling 4 LCD panel modules as shown in FIG. 3. First, 4 pieces of LCD panel module 100 as shown in FIG. 3 are prepared.

A large base substrate TEMP, for example, a tempered glass substrate, having a diagonal length corresponding to target large display device is prepared. For using at outdoor, the base substrate TEMP may be made of tempered glass or reinforced acryl plate for ensurging strength against external impacts and scratches.

The outdoor display panel is for presenting public information under sunlight. Therefore, it is preferable for the outdoor display panel to have good properties with which the information can be shown in any direction all day long. On the outer surface of the base substrate TEMP, an anti-reflection layer ARL is coated for preventing diffused reflection. The anti-reflection layer ARL can be attached as an additional film type on the surface of the base substrate TEMP. Furthermore, it is preferable for the anti-reflection layer ARL to be a film type having adhesiveness enough to prevent the base substrate TEMP from scattering in the air when it is broken.

Next, on the inner surface of the base substrate TEMP, lines are drawn for dividing the surface of the base substrate TEMP into 4 sections. For example, a horizontal line dividing the base substrate TEMP into two sections in vertical direction and a vertical line dividing the base substrate TEMP into two sections in horizontal direction are drawn. Along the lines, black matrix BM is formed. The black matrix BM hides the joining part between two tiling LCD panel module 100. (FIG. 4A)

On the innser surface of the base substrate TEMP, an index matching oil INDO is coated covering the black matrix BM. The index matching oil INDO is a gel type material having the same refraction index with the refraction index of the TFT substrate TFTS and the color filter substrate CFS of the LCD panel module 100. For example, the base substrate TEMP is tempered glass, and the TFT substrate TFTS and the color filter substrate CFS of the LCD panel module 100 are geneal glasses. In that case, the refractions of the substrates TEMP, TFTS and CFS is 1.54. Therefore, the refraction index of the index matching oil INDO is preferably in range of 1.5˜1.6. (FIG. 4B)

At the first section of the base substrate TEMP, the first LCD panel module 101 is disposed on the inner surface having the index matching oil INDO. Especially, the two neighboring sides having the driver ICs DRIC are disposed at the out circumferences of the base substrate TEMP. Furthermore, the other two neighboring sides of the first LCD panel module 101 are aligned with the black matrix BM, especially, overlapped with half width of the black matrix BM. (FIG. 4C)

At the second section of the base substrate TEMP, the second LCD panel module 102 is disposed. The two neighboring sides having the driver ICs DRIC are disposed at the out circumferences of the base substrate TEMP. The other two neighboring sides of the second LCD panel module 102 are aligned with the black matrix BM, especially, overlapped with half width of the black matrix BM. (FIG. 4D)

At the third section of the base substrate TEMP, the third LCD panel module 103 is disposed. The two neighboring sides having the driver ICs DRIC are disposed at the out circumferences of the base substrate TEMP. The other two neighboring sides of the third LCD panel module 103 are aligned with the black matrix BM, especially, overlapped with half width of the black matrix BM. (FIG. 4E)

At the fourth section of the base substrate TEMP, the fourth LCD panel module 104 is disposed. The two neighboring sides having the driver ICs DRIC are disposed at the out circumferences of the base substrate TEMP. The other two neighboring sides of the fourth LCD panel module 104 are aligned with the black matrix BM, especially, overlapped with half width of the black matrix BM. After that, by hardening the index matching oil INDO, the first, second, third and fourth LCD panel modules are fixed on the base substrate TEMP at each allocated positions, respectively. (FIG. 4F)

After that, performing post-processes for mounting additional equipments for the large area LCD panel, the outdoor large area LCD is completed. For example, if each diagonal length of each LCD panel module 101 to 104 is 52 inches, the finally completed outdoor large LCD panel has 104 inches diagonal length.

While the embodiment of the present invention has been described in detail with reference to the drawings, it will be understood by those skilled in the art that the invention can be implemented in other specific forms without changing the technical spirit or essential features of the invention. Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

1. A flat panel display device comprising:
a reinforced base substrate;
an anti-reflection film disposed on an outer surface of the reinforced base substrate;
black matrixes dividing a inner surface of the reinforced base substrate into multiple sections;
an index matching oil disposed on the inner surface of the reinforced base substrate; and
a plurality of flat panel modules tiled on the reinforced base substrate bordering the black matrixes.

2. The device according to the claim 1, wherein the plurality of flat panel modules include a liquid crystal display panel.

3. The device according to the claim 1, wherein the plurality of flat panel modules include an organic light emitting diode display panel.

4. The device according to the claim 1, wherein the black matrixes divides the inner surface of the reinforced base substrate into 4 sections, and the plurality of flat panel modules include a first, a second a third and a fourth plurality of flat panel modules disposed on each section of the multiple sections, respectively.

5. A method for manufacturing a flat panel display device comprising:
preparing a reinforced base substrate;
disposing an anti-reflection film on an outer surface of the reinforced base substrate;
forming black matrixes dividing a inner surface of the reinforced base substrate into multiple sections;
disposing an index matching oil on the inner surface of the reinforced base substrate over the black matixes;
tiling a plurality of flat panel modules at the multiple section of the reinforced base substrate; and
hardening the index matching oil.

6. The method according to the claim 5, wherein the plurality of flat panel modules include a liquid crystal display panel.

7. The method according to the claim 5, wherein the plurality of flat panel modules include an organic light emitting diode display panel module.

8. The method according to the claim 5, wherein the black matrixes is formed to divide the inner surface of the reinforced base substrate into 4 sections, and
wherein the tiling the plurality of flat panel moules comprises:
tiling a first flat panel module at a first section of the reinforced base substrate;
tiling a second flat panel module at a second section of the reinforced base substrate;
tiling a third flat panel module at a third section of the reinforced base substrate; and
tiling a fourth flat panel module at a fourth section of the reinforce base substrate.
